(19) United States
(12) Patent Application Publication
(10) Pub. No.: US 2015/0358466 A1
(43) Pub. Date: Dec. 10, 2015

(54) Call Center Direct Access

(71) Applicant: THOMSON LICENSING, Issy-Les-Moulineaux (FR)

(72) Inventors: Jun XU, Beijing (CN); Zhigang ZHANG, Beijing (CN); Yangfeng ZHANG, Beijing (CN)

(73) Assignee: Thomson Licensing

(21) Appl. No.: 14/435,612

(22) PCT Filed: Oct. 23, 2012
(86) PCT No.: PCT/CN2012/083371

§ 371 Date: Apr. 14, 2015

(51) Int. Cl. H04M 3/51; H04W 76/02; H04M 1/725

(52) U.S. Cl. CPC H04M 3/5175; H04M 1/72597; H04W 76/02; H04M 3/5183

(57) ABSTRACT

A map processor residing on a mobile device displays a call center hierarchy map based, in part, on a dialed call center number. User interactions with the map are then processed by the map processor to determine a desired call center connection. This information is used by the map processor to establish a direct connection with the desired node of the call center hierarchy map. In other instances, the mobile device interacts with a call center exchange, hierarchy map server, statistical server and a call center direct line to facilitate in providing a call center hierarchy map and a direct connection.

### BACKGROUND

Conventional auto-answer call centers including e-commerce, credit card, etc. have hierarchical instructions requiring a user to input a response to each prompt of the call center. The navigation process to the final target dialing number is time consuming and boring. For those people who travel abroad and their mobile phones use roaming service, this kind of navigation incurs extra expenses and wastes time.

### SUMMARY

A headend of a call center system sends a user a visual hierarchy map upon their first request. A client application residing on a user's device loads the hierarchy map with corresponding instructions on a screen and monitors a user's input. A user browses the hierarchy map and locates a final number sequence they would like to dial, and selects the specific leaf node of the hierarchy tree for that number sequence. The dialing instructions are sent to a backend of the call center system, and a communication circuit is constructed accordingly. Meanwhile, the number is stated on the headend for optimizing the rendering of the hierarchy map. For subsequent operations, the hierarchy map is arranged according to the dialing count, i.e., the more the number is dialed, the higher it will be located in each level of the hierarchy map.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an example of a call center system and its subsystems.

FIG. 2 is an example of a user interface with graphics on a client side application residing on a user's device.

FIG. 3 is an example data structure that resides on a statistics server.

FIG. 4 is an example call center system residing on a mobile device.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

A message, including an instruction hierarchy, is sent to a user's device (landline, mobile device, television, monitor, etc.) after the user calls a call center (call centers can be from a service provider and/or directly from a business, etc.). Once the user selects a menu item in a call menu hierarchy, the user's device automatically interacts with the call center at the appropriate point. This technique has many advantages over the traditional call center voice hierarchy. In the traditional call center, a user must listen to menu functions of all the keys one by one in a single step before they can determine which key they should press. This is very time consuming and requires the user to start the menu listing program over if they do not hear the appropriate function the first time. Voice prompting is different from text or picture prompting. The voice prompting can cause errors in dialing, especially in noisy environment. The conventional methods are very tedious and time consuming, costing the user a lot of time and money, especially when they travelling abroad where phone rates are typically at a premium. With these types of conventional methods, the instruction or menu hierarchy always prompts the user in the same sequence. It cannot modify the sequence unless the sequence is adjusted manually on the headend side—which is very cumbersome.

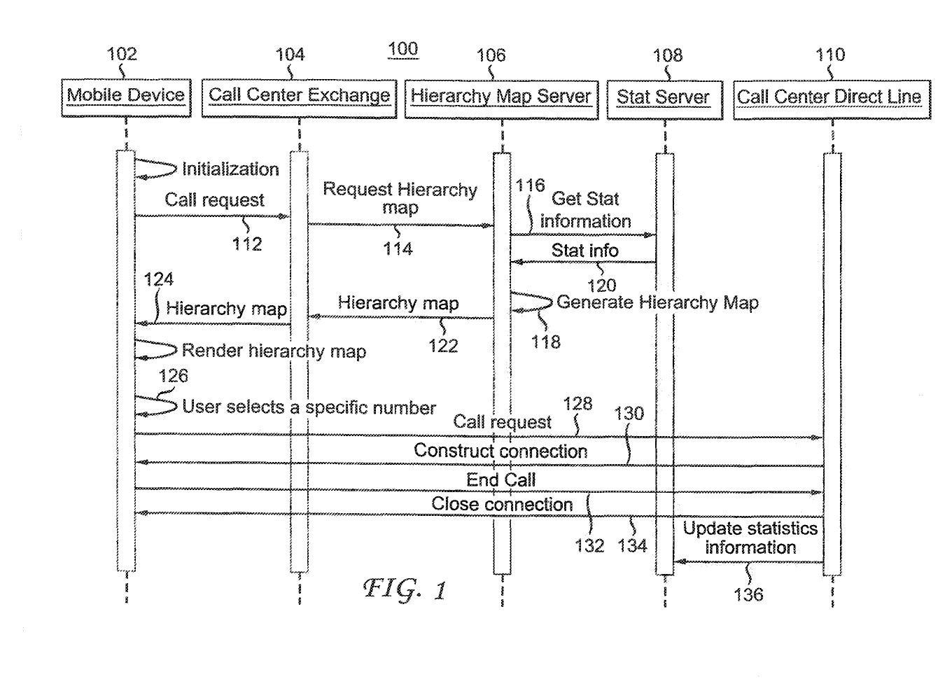

In one instance of a call center system 100 as illustrated in FIG. 1, there are five main subsystems including a mobile device 102, a call center exchange 104, a hierarchy map server 106, a statistics server 108 and a call center direct line 110. Once a user launches a call request 112 to the call center exchange 104, it will request hierarchy map 114 from the hierarchy map server 106. Then the hierarchy map server 106 gets statistical information 116 from the statistics server 108. On the hierarchy map server 106, it generates a hierarchy map 118 according to the statistical information 120, and then returns the hierarchy map 122 to the call center exchange 104, and finally 124 to the mobile device 102. Once the user gets to view the hierarchy map on their mobile device, they can then select a specific leaf node in the hierarchy map 126, and send a call request 128 to the call center direct line 110. Then connection between mobile device 102 and the call center direct line 110 is then constructed 130, and the user can directly communicate with the call center direct line 110 until they end the call 132 and close the connection 134. The call center direct line 110 then updates the statistics information 136 to statistical server 108.

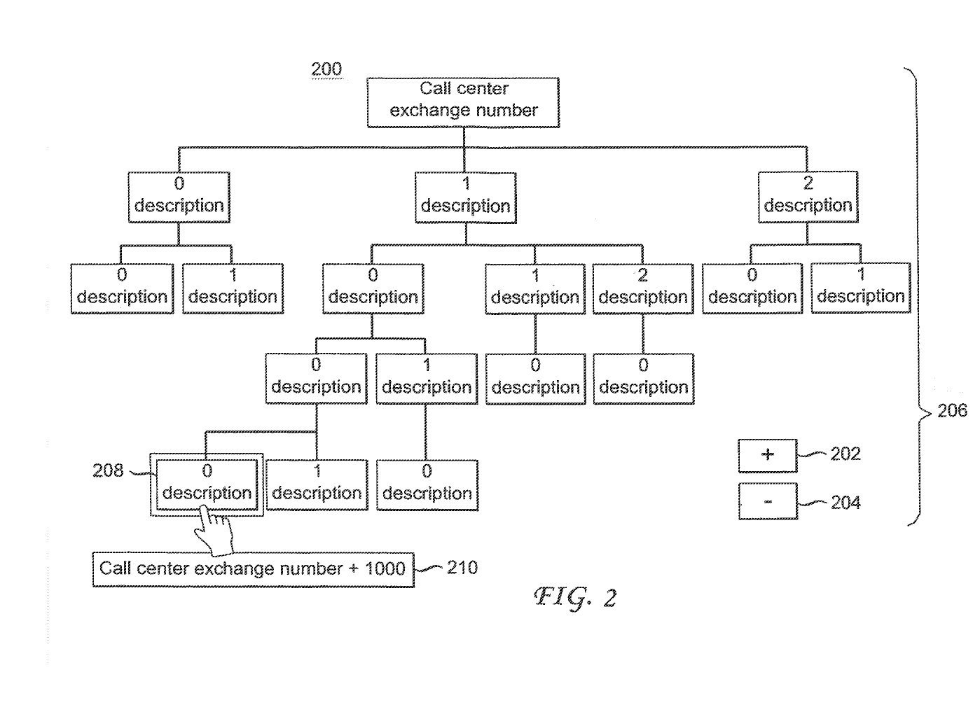

FIG. 2 illustrates an example of a user interface 200 with graphics on a client side application residing on a user's device. In one instance, an end user can zoom in 202 and out 204 by selecting a menu item, and/or directly using their fingers on a screen to zoom in and out on a whole hierarchy map 206. Once a user is familiar with the hierarchy map 206, they can also directly move their finger to a specific leaf node, e.g., the lowest layer node 208 in the hierarchy map 206. Hint information 210 pops up prompting a specific usage message relating to a direct line number. The user can then directly select this menu item 208 to get a connection with a call center direct line. In one instance, on each layer, the numbers are arranged according to the Arabic number sequence. In other instances, the numbers on each layer can be placed according to statistics information, which is discussed infra.

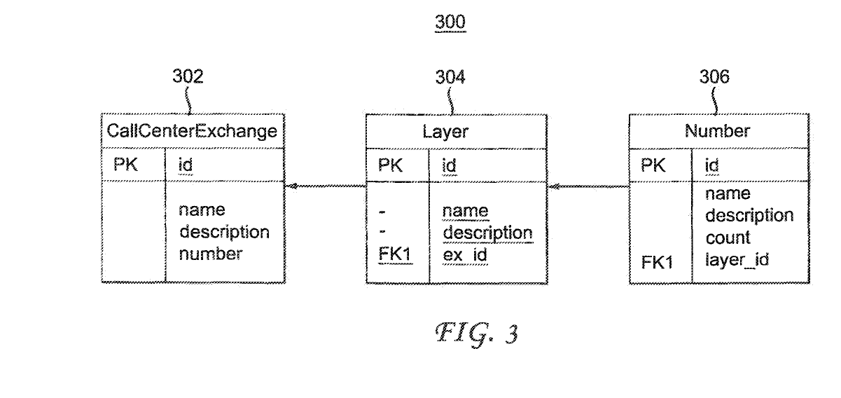

An example data structure 300 of one instance that resides on a statistics server is shown in FIG. 3. There are three tables 302-306, which are respectively table “CallCenterExchange” 302, table “Layer” 304, and table “Number”306. In this example, a hierarchy map is generated according to the following data structure. The top layer is the call center exchange number from the table “CallCenterExchange” 302, and then the numbers are retrieved from the table “Number” 306 according to their layer_id, e.g., one layer by one layer. On a specific layer, the numbers are lined up according to a descent sequence calculated by a field “count” in table “Number” 306.

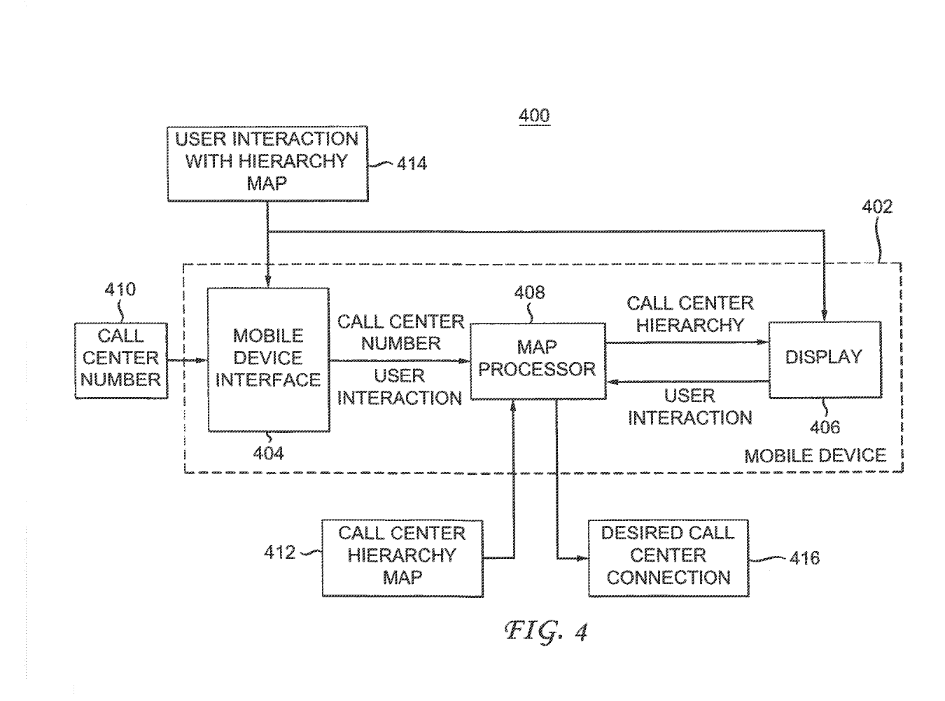

In one example, system 400 illustrated in FIG. 4, a mobile device 402 comprises a mobile device interface 404 and a display 406. In some mobile devices, the interface 404 and the display 406 are the same mechanical structure (e.g., a touch screen, etc.). On other mobile devices, the display 406 is separate from a user input interface 404 such as a keyboard, mouse and the like. A map processor 408 resides on the mobile device 402 and interacts with the mobile device interface 404 and the display 406. In this example, a user enters a call center number 410 into the mobile device interface 404. This can be done by directly entering keystrokes on a keypad, via a touch screen and/or by selecting a number from a contact list to command the mobile device to dial the call center number 410.

The map processor 408 can receive the dialed call center number 410 at the time of dialing to prepare it for receiving a call center hierarchy map 412. In other instances, the map processor 408 does not receive the call center number 410 at the time of dialing but monitors communication means of the mobile device for incoming hierarchy maps. In either case, when the map processor 408 receives the call center hierarchy map 412, it processes the map information, if necessary, and sends it to the display 406 of the mobile device 402. The user is then presented with the call center hierarchy map 412 and can select which node of the hierarchy they desire to contact. This user interaction with the hierarchy map 414, whether via the mobile device interface 404 and/or via the display 406, is then forwarded to the map processor 408. The map processor 408 then determines a desired call center connection 416 and transmits this information via a communication means of the mobile device 402 to establish a direct connection for the user.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that provides call center information, comprising:
a map processor residing in a mobile device that receives a call center hierarchy map, displays the call center hierarchy map on the mobile device and accepts user input to establish a direct communications link with a call center.

2. The system of claim 1, wherein the map processor receives a dialed call center number at the time of dialing and subsequently monitors a communication means of the mobile device for a call center hierarchy map.

3. The system of claim 1, wherein the map processor receives a call center hierarchy map with frequently contacted numbers shown at higher levels as the dialing frequency of the contacted numbers increases.

4. The system of claim 1, wherein the map processor displays a usage message in proximity of a leaf node of the call center hierarchy map.

5. The system of claim 1, wherein the map processor monitors a communication means of the mobile device for a call center hierarchy map.

6. The system of claim 1, wherein the map processor interacts with at least one of an interface of the mobile device and a display of the mobile device to accept user input regarding a selected call center connection.

7. The system of claim 6, wherein the map processor receives the call center hierarchy map from at least one of a call center exchange and a hierarchy map server.

8. The system of claim 1, wherein the map processor receives a call center hierarchy map from at least one of a Wide Area Network communication connection of the mobile device and a cellular communication connection of the mobile device.

9. A method for providing call center information, comprising:
receiving, on a mobile device, a call center hierarchy map associated with a dialed call center number;
displaying the call center hierarchy map interactively on the mobile device;
receiving a user selection from the interactive call center hierarchy map; and
transmitting a request for a call center connection associated with the user selection.

10. The method of claim 9 further comprising:
receiving the call center hierarchy map over a communication means of the mobile device.

11. The method of claim 10 wherein the communication means comprising at least one of a Wide Area Network communication connection and a cellular communication connection.

12. The method of claim 9 further comprising:
displaying a usage message in proximity of a leaf node of the call center hierarchy map.

13. The method of claim 9 further comprising:
generating a call center hierarchy map with frequently contacted numbers shown at higher levels as the dialing frequency of the contacted numbers increases.

14. The method of claim 9 further comprising:
displaying the call center hierarchy map with nodes representing direct connections that are selectable by a user.

15. The method of claim 9 further comprising:
transforming the received call center hierarchy map to fit a display associated with the mobile device.

16. The method of claim 9 further comprising:
communicating between the mobile device and at least one of a call center exchange, a hierarchy map server, a statistical server and a call center direct line to generate the call center hierarchy map and establish the call center connection associated with the user selection.

17. A system that establishes call center direct connections, comprising:
means for receiving, on a mobile device, a call center hierarchy map associated with a dialed call center number;
means for displaying the call center hierarchy map interactively on the mobile device;
means for receiving a user selection from the interactive call center hierarchy map; and
means for transmitting a request for a call center connection associated with the user selection.

18. The system of claim 17 further comprising:
a means for receiving the call center hierarchy map over at least one type of communication means of the mobile device.
